(19) United States
(12) Patent Application Publication
(10) Pub. No.: US 2020/0055304 A1
(43) Pub. Date: Feb. 20, 2020

(54) INK TRANSFER ROLLER WITH A REMOVABLE HOLLOW-CORE ELASTOMER ROLLER BODY ON A REUSABLE HANGER SHAFT

(71) Applicant: Pacesetter Graphic Service Corporation, Acworth, GA (US)

(72) Inventor: Robert Allen, Ackworth, GA (US)

(21) Appl. No.: 16/103,957

(22) Filed: Aug. 16, 2018

(51) Int. Cl. B41F 3/54; B41F 17/00

(52) U.S. Cl. CPC B41F 3/54; B41F 17/006

(57) ABSTRACT

An ink transfer roller with a hollow-core elastomer roller body is carried on a reusable hanger shaft. Bearings reduce friction while the steel shaft dissipates heat more readily than the aluminum shaft used in conventional transfer rollers. The hollow-core elastomer roller body reduces heat transfer from the shaft to the roller body. A lock collar on one end and a snap ring on the other end of the roller body hold the roller body in place on the shaft. A set screw can be tightened to secure the lock collar to the shaft to hold the roller in place. These features allow the roller body to be easily removed and replaced on the shaft, which reduces maintenance costs. The hangers on the ends of the shaft allow a fully assembled ink transfer roller to be easily removed and replaced in the printing machine, which further reduces maintenance costs.

### TECHNICAL FIELD

The present invention relates to industrial printing machines, such as those used to print drink cups and cans; and, more particularly, to an ink transfer roller that includes a removable hollow-core elastomer roller body on a reusable hanger shaft.

### BACKGROUND

Ink transfer rollers for high speed printing machines typically include roller bodies permanently attached to aluminum shafts with bearings on the ends. These ink transfer rollers rotate at high speed, which can cause the rollers to become heated. Conventional ink transfer rollers do not dissipate heat well, which causes the rollers to overheat and malfunction. The entire roller including the roller body, shaft and bearings must typically be removed and discarded when the roller requires replacement. In many cases, the roller body may be worn out while the shaft and bearings are still in good shape. Nevertheless, the entire roller must be removed and replaced because the entire roller is configured as an integral unit. As a result, there is continuing need for improved ink transfer rollers for high speed printing machines.

### SUMMARY

The invention includes a printing machine, such as a drink cup or can printing machine, containing one or more ink transfer roller and an ink transfer roller for the printing machine. In a particular embodiment, the ink transfer roller includes a hollow-core elastomer roller body on a reusable hanger shaft. The roller body includes a first bearing housing integrally formed into a first end of the holler body, and a second bearing housing integrally formed into a second end of the holler body. A first bearing insert is press fit into the first bearing housing, and a second bearing insert is press fit into the second bearing housing. The reusable polished steel hanger shaft extends through the first and second bearings. A first hanger is connected to a first end of the shaft, and a second hanger connected to a second end of the shaft. The hangers are configured to be received with non-rotating engagement by hanger supports in the high-speed drink cup or can printing machine. A lock collar positions the first end of the roller body on the shaft, and a snap ring positions the second of the roller body on the shaft.

It will be understood that additional techniques and structures for ink transfer rollers will become apparent from the following detailed description of the embodiments and the appended drawings and claims.

### BRIEF DESCRIPTION OF THE FIGURES

FIG. 1 is a conceptual illustration of an industrial drink cup printing machine utilizing ink transfer rollers with hollow-core elastomer roller bodies and reusable hanger shafts.

FIG. 2 is a perspective view of the ink transfer roller.

FIG. 3 is a front view of the ink transfer roller.

FIG. 4 is a first assembly view of the ink transfer roller.

FIG. 5 is a second assembly view ink transfer roller.

FIG. 6 is a third assembly view of the ink transfer roller.

### DETAILED DESCRIPTION

Embodiments of the invention may be realized in an ink transfer roller that solves the overheating and difficult maintenance problems of conventional ink transfer rollers. Conventional ink transfer rollers have solid roller bodies permanently attached to the shaft, which carries bearings on the ends that allow the shaft to rotate with respect to the printing machine. The innovative ink transfer roller includes a hollow-core elastomer roller body carried on a reusable polished steel hanger shaft. The roller body includes bearings that press fit into bearing housings built into the roller body. The polished steel hanger shaft includes hangers rather than bearings on the ends of the shaft, which avoids the need for rolling engagement between the shaft and the printing machine. As a result, the roller body rotates on the shaft, while the shaft remains fixed with respect to the printing machine. This configuration dissipates heat more readily than the aluminum shaft used in conventional ink transfer rollers. The hollow-core elastomer roller body also reduces heat transfer from the shaft to the roller body, which further reduces overheating of the roller body.

A lock collar and snap ring position roller body on the shaft. A set screw in the lock collar allows the roller body to be easily removed from the shaft. To reduce maintenance cost, the roller body can be quickly removed and replaced, while the shaft, bearings and other components can be reused for multiple roller bodies. The hanger engagement between the shaft and the printing machine allow a fully assembled roller to be easily removed and reinstalled in the printing machine, which further reduces maintenance costs.

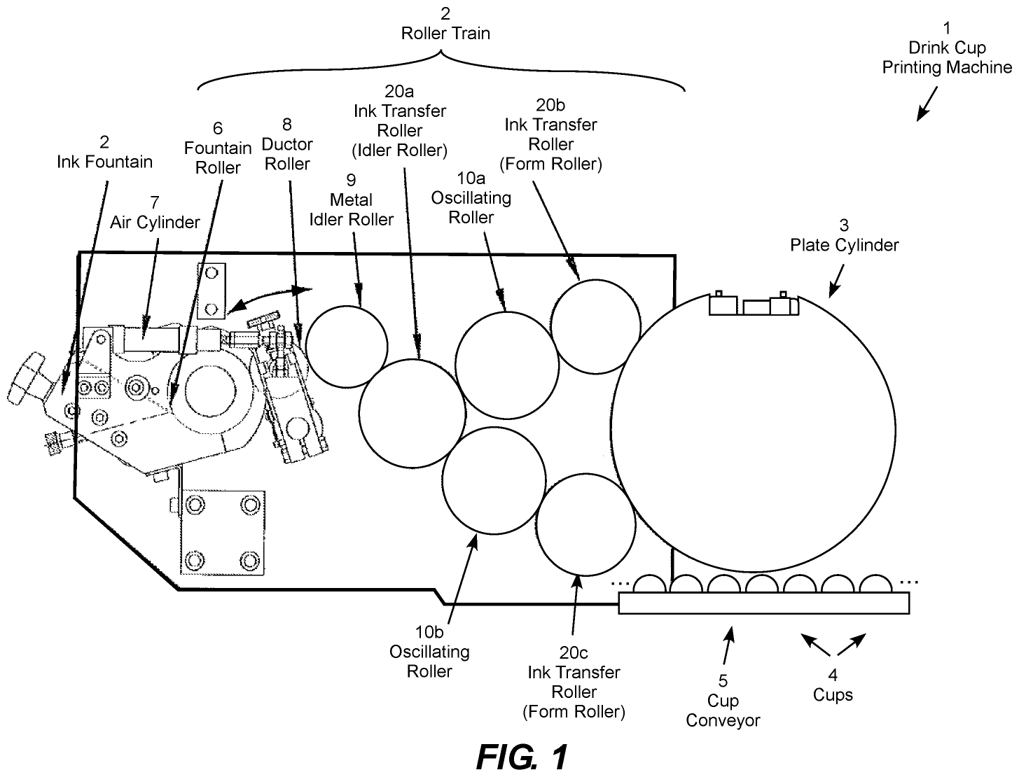

FIG. 1 shows a conceptual illustration of a drink cup printing machine 10 using a number of ink transfer rollers 20a-c with removable hollow-core elastomer roller bodies carried on reusable hanger shafts. The printing machine 1 is merely illustrative because the ink transfer rollers 20a-c can be used in any type of drink cup or can printing machine using elastomer ink transfer rollers and, therefore, are not limited to any particular type of printing machine or any particular ink transfer location in the printing machine. In general, particular embodiments of the ink transfer rollers 20a-c may be realized in high speed printing machines, such as those used to print crisp, high quality images on drink cups or cans. These machines require high quality, highly consistent printing at machine speeds often in the range of 600 to 800 images per minute in accordance with current industry standards. While three or more ink colors are often printed, only one ink fountain and associated train of rollers is shown in FIG. 1 to avoid cluttering the figure. This particular figure therefore depicts one representative ink train for applying one color of ink, and several similar ink trains may be utilized to print multiple colors. For this ink train, the ink enters the machine at the ink fountain 2 and travels through an ink transfer roller train 2 and onto a plate cylinder 3, which delivers the ink onto the cups 4 as they pass on a cup conveyor 5.

In this particular embodiment, the innovation is embodied in the elastomer ink transfer rollers 20a-c, which are part of the roller train 2. The ink fountain 1 delivers into to the fountain roller 6. An air cylinder 7 moves a ductor roller 8 into engagement with the fountain roller 6 to pick up ink from the ink fountain 2. A metal idler roller 9 transfers the ink from the ductor roller 8 to an elastomer ink transfer roller 20a, which is also known as an idler roller. The ink transfer roller 20a transfer the ink to oscillating rollers 10a-b, which move into and out of engagement with the ink transfer rollers 20a-c to pick up ink in the correct locations to transfer the ink to the printing plate on the plate cylinder 3. Although the specific configuration of the roller train 2 is not an aspect to the invention, each ink line of the printing machine typically includes at least one elastomer ink transfer roller as well as two oscillating rollers that move into and out of engagement with the form ink transfer rollers to apply ink to the proper portions of the rollers.

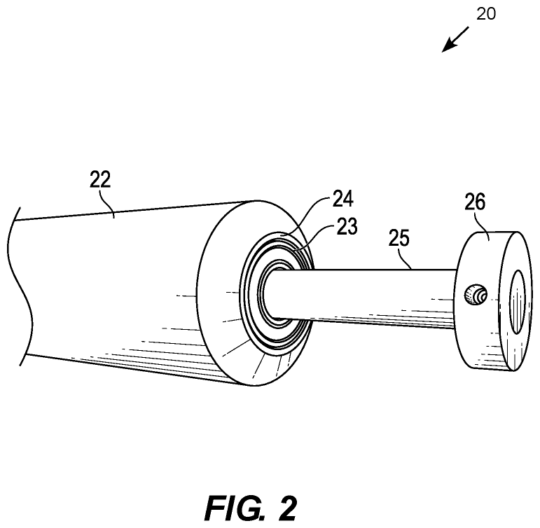

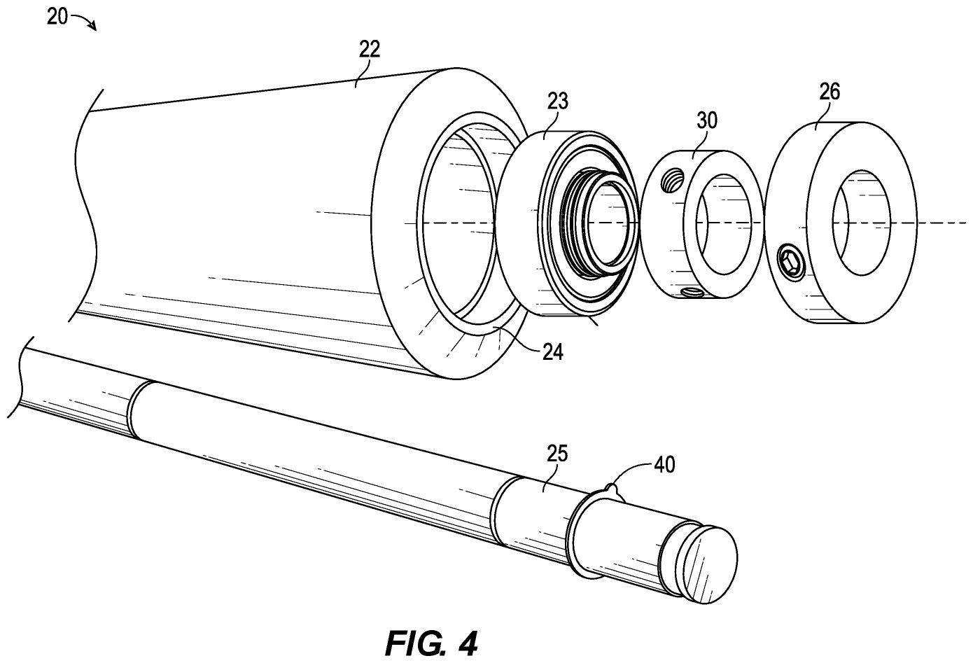

FIGS. 2-6 show the details of the ink transfer roller 20. FIG. 2 shows one end of the ink transfer roller 20, which includes a hollow-core elastomer roller body 22 and a bearing insert 23 that press fits into a bearing housing 24 integrally formed into the roller body. A turned, ground and polished steel shaft 25 extends through the bearing insert 23 shown in FIG. 2 as well as a similar bearing insert on the opposing end of the roller body. The shaft 25 terminates at the hanger 26 shown in FIG. 2 on one end, and in a similar hanger at the opposing end of the shaft. The hangers 26 are received into hanger supports in the printing machine 10 for easy installation and removal of a fully assembled ink transfer roller 20. Due to the use of the bearings 23 between the roller body 22 and the shaft 25, a rolling interface is not required between the hangers 26 and the hanger supports. This facilitates installation and removal of the ink transfer roller 20 in the printing machine. The polished surface of the steel shaft 25 surface allows for close tolerance between the shaft and the lock collar 30 as well as the hangers 26. The snap ring 40 shown in FIG. 4 is not included in FIG. 2 to avoid cluttering the figure.

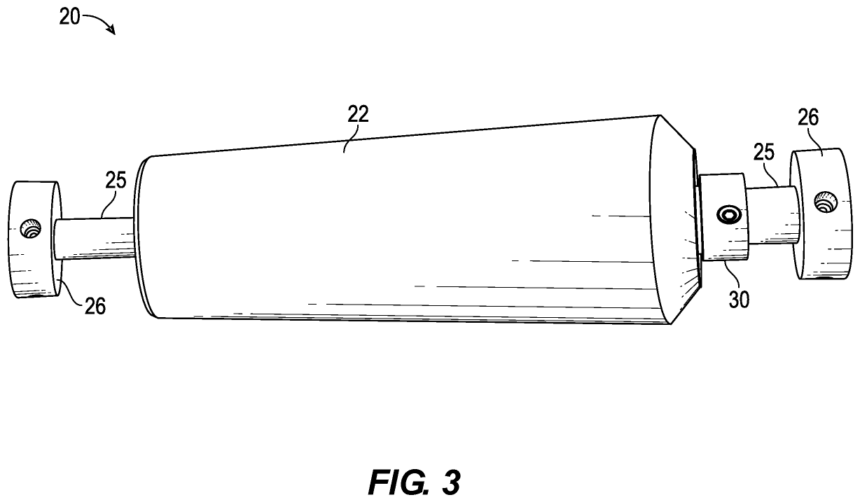

FIG. 3 shows the assembled ink transfer roller 20, which includes a lock collar 30 to hold one end of the roller body 22 in place on the shaft 25. FIG. 4 shows an assembly view of the roller 20 including the snap ring 40 used to hold the roller body 22 in place on the shaft 25 on the opposing end of the roller body 22. Set screws hold the lock collar 30 and the hangers 26 in place the shaft 25, while the snap ring 40 fits into a groove formed into the shaft. The set screws of the lock collar 30 and the hangers 26 may also fit into grooves formed in the shaft 25. While this configuration is preferred, it will be appreciated that lock collars could be used on both ends of the roller body, snap rings could be used on both ends of the roller body, or other types of fasteners could be used to position the roller body on the shaft.

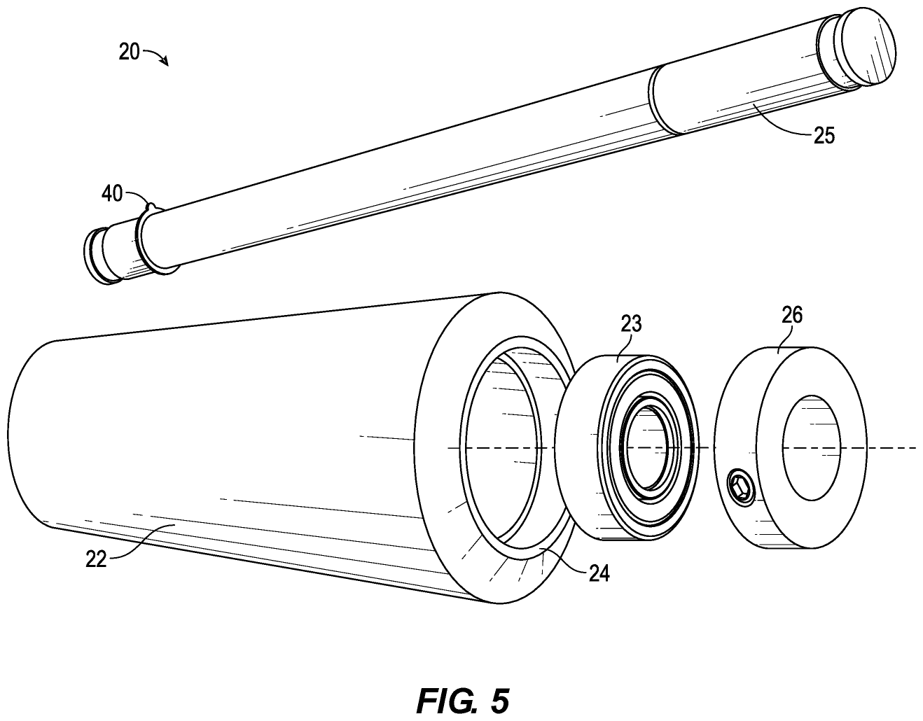

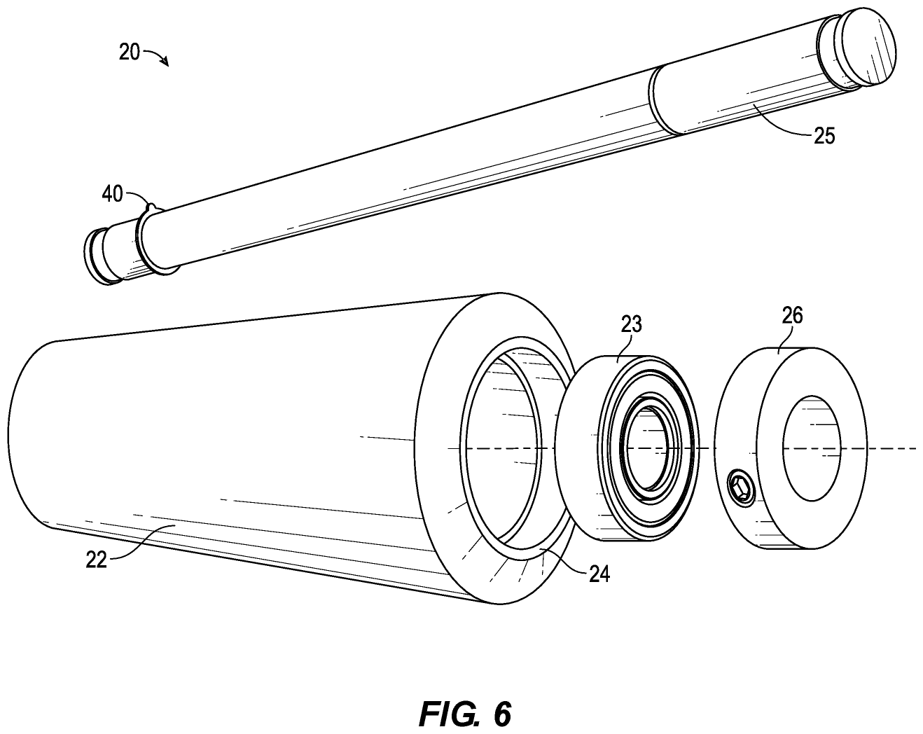

FIGS. 5 and 6 show additional assembly views of the ink transfer roller 20. To assemble the roller 20, the bearings 23 press fit into the bearing housings 24 on the roller body 22 and the snap ring 40 is snap fit into the corresponding groove on the shaft 25. The shaft is then extended through the bearings 23 until the snap ring 40 is positioned against one of the bearings to position one end of the roller body 22 on the shaft 25. The lock collar 30 is then inserted over the opposing end of the shaft 25 and positioned against the opposing bearing 23 to position the roller body 22 on the shaft 25 between the snap ring 40 and the lock collar 30. The set screw in the lock collar 30 is then tightened to secure the lock collar to the shaft 25. The hangers 26 are then installed on the opposing ends of the shaft 25. The set screws in the hangers 26 are tightened to secure the hangers on opposing ends of the shaft 25.

The ink transfer roller 20 produces a number of advantaged over the conventional design with a solid core roller body permanently attached to an aluminum shaft with bearings on either end. First, the roller body 22 can be easily removed from the shaft 25. The reduces maintenance costs by allowing the roller body to be replaced, while the shaft, bearings, hangers and other components can be reused with multiple roller bodies. Conventional ink transfer rollers require the entire assembly to be replaced and discarded when the roller body is worn out. Second, the steel shaft 25 dissipates heat more easily than the aluminum shaft used in conventional ink transfer rollers, which reduces heating of the roller 20. Third, the hollow-core elastomer roller body 22 reduces heat transfer from the shaft 25 to the roller body, which further reduces heating of the roller body. Fourth, the non-rolling engagement between the hangers 26 on the shaft 25 allows for easy and quick removal and replacement of an assembled roller 20, further reducing maintenance costs.

In view of the foregoing, it will be appreciated that present invention provides significant improvements to ink transfer rollers for high-speed drink cup or can printing machines. The foregoing relates only to the exemplary embodiments of the present invention, and that numerous changes may be made therein without departing from the spirit and scope of the invention as defined by the following claims.

The invention claimed is:

1. An ink transfer roller for a high-speed drink cup or can printing machine, comprising:
a hollow-core elastomer roller body;
a polished steel shaft removably extending through the roller body;
wherein the shift is configured for rolling engagement between the shaft and the roller body, and non-rotating engagement between the shaft and the printing machine.

2. The ink transfer roller of claim 1, further comprising a first hanger connected to a first end of the shaft, and a second hanger connected to a second end of the shaft, wherein the hangers are configured to be received with non-rotating engagement by hanger supports in the printing machine.

3. The ink transfer roller of claim 1, further comprising,
a first bearing housing integrally formed into a first end of the holler body, and a second bearing housing integrally formed into a second end of the holler body; and
a first bearing insert press fit into the first bearing housing, and a second bearing insert press fit into the second bearing housing;
wherein the hollow-core elastomer shaft extends through the first and second bearings.

4. The ink transfer roller of claim 1, further comprising a lock collar positioning the first or second end of the roller body on the shaft.

5. The ink transfer roller of claim 1, further comprising a snap ring positioning the first or second end of the roller body on the shaft.

6. The ink transfer roller of claim 1, further comprising:
a lock collar positioning the first end of the roller body on the shaft; and
a snap ring positioning the second end of the roller body on the shaft.

7. An ink transfer roller for a high-speed drink cup or can printing machine, comprising:
a hollow-core elastomer roller body comprising a first bearing housing integrally formed into a first end of the holler body, and a second bearing housing integrally formed into a second end of the holler body;
a first bearing insert press fit into the first bearing housing, and a second bearing insert press fit into the second bearing housing;
a polished steel shaft extending through the first and second bearings;
a lock collar positioning the first end of the roller body on the shaft;
a snap ring positioning the second of the roller body on the shaft;
a first hanger connected to a first end of the shaft, and a second hanger connected to a second end of the shaft, wherein the hangers are configured to be received with non-rotating engagement by hanger supports in the high-speed drink cup or can printing machine.

8. A high-speed drink cup or can printing machine, comprising a train of rollers comprising one or more ink transfer rollers, wherein each ink transfer roller comprises:
a hollow-core elastomer roller body;
a polished steel shaft extending through the roller body;
wherein the shift is configured for rolling engagement between the shaft and the roller body, and non-rotating engagement between the shaft and the printing machine.

9. The high-speed drink cup or can printing machine of claim 8, further comprising a first hanger connected to a first end of the shaft, and a second hanger connected to a second end of the shaft, wherein the hangers are configured to be received with non-rotating engagement by hanger supports in the high-speed drink cup or can printing machine.

10. The high-speed drink cup or can printing machine of claim 9, further comprising,
a first bearing housing integrally formed into a first end of the holler body, and a second bearing housing integrally formed into a second end of the holler body; and
a first bearing insert press fit into the first bearing housing, and a second bearing insert press fit into the second bearing housing;
wherein the hollow-core elastomer shaft extends through the first and second bearings.

11. The high-speed drink cup or can printing machine of claim 10, further comprising a lock collar positioning the first or second end of the roller body on the shaft.

12. The high-speed drink cup or can printing machine of claim 11, further comprising a snap ring positioning the first or second end of the roller body on the shaft.
